(19) United States
(12) Patent Application Publication
(10) Pub. No.: US 2026/0001496 A1
(43) Pub. Date: Jan. 1, 2026

(54) ARRANGEMENT FOR GAP COVERAGE

(71) Applicant: Ford Global Technologies, LLC, Dearborn, MI (US)

(72) Inventors: Max Kerschbaum, Frechen (DE); Bruno Costa, Frechen (DE)

(73) Assignee: Ford Global Technologies, LLC, Dearborn, MI (US)

(21) Appl. No.: 19/251,215

(22) Filed: Jun. 26, 2025

(30) Foreign Application Priority Data
Jun. 27, 2024 (EP) 24185155.9

(51) Int. Cl. B60R 13/02; B62D 1/16

(52) U.S. Cl. CPC B60R 13/0256; B62D 1/16

(57) ABSTRACT

An arrangement for gap coverage for a variable gap between an adjustable steering column and a dashboard of a vehicle has a steering column trim and a gap coverage device. The gap coverage device has a holding device and a flexible gap coverage element, which at one side is detachably fastened with a frictional positive fit to the holding device and at the other side is connectable to a fastening element. The holding device having the flexible gap coverage element attached thereto is in turn detachably fastened with a frictional positive fit to the steering column trim.

### CROSS-REFERENCE TO RELATED APPLICATION

This application claims priority to and the benefit of European Application No. 24185155.9, filed on Jun. 27, 2024. The disclosure of the above application is incorporated herein by reference.

### FIELD

The present disclosure relates to an arrangement for gap coverage for a variable gap between an adjustable steering column and a dashboard of a vehicle, having a steering column trim and a gap coverage device.

### BACKGROUND

The statements in this section merely provide background information related to the present disclosure and may not constitute prior art.

A vehicle generally has a dashboard and an adjustable steering column, wherein the steering column, or the steering wheel arranged thereon, can be set to the body size and position of the particular vehicle driver through adjustment of the steering column. Here, a spacing between the dashboard and the steering wheel arranged on the steering column is decreased or increased. If the steering column is pivoted, a tilt angle between the steering column and a floor of a body of the vehicle is varied. In general, the steering column is equipped with a steering column trim, which is in particular of multi-part form. The steering column trim is movable or pivotable jointly with the steering column. It is intended here that, when the steering column rotates, the steering column trim does not rotate together with the steering column. As is known, the steering column and the steering column trim project through an opening in the dashboard, wherein the opening is larger than the steering column trim. A gap is thus formed between the dashboard and the steering column trim. The gap is generally at least partially covered, that is to say closed, so to speak, by a flexible gap coverage element. Since the gap coverage element is flexible, displacement and/or pivoting movements of the steering column trim relative to the dashboard can be compensated for by the gap coverage element. The gap coverage element may be of planar form, and is generally integrally bonded to the steering column trim. Here, the gap coverage element is connected to the steering column trim either by means of a welding process, for example by ultrasonic welding, or by means of adhesives. Both options greatly increase complexity of the assembly process. In particular, the use of ultrasonic welding equipment having a specific tool, or the use of adhesives adapted to different environmental influences, are disadvantageous here. The material consumption is also to be regarded as disadvantageous because, in the case of the conventional connecting processes, there must always be an excess of material that must be disposed of after the connection has been produced by ultrasonic welding or adhesive bonding; under certain circumstances it is then desired, in order to protect the environment, for the waste material to be disposed of without the possibility of it being put to some other use, owing to possible adherent adhesive residues or uneven cut edges.

### SUMMARY

This section provides a general summary of the disclosure and is not a comprehensive disclosure of its full scope or all of its features.

The disclosure is based on the specifying of an arrangement for gap coverage of the type mentioned in the introduction, with which the aforementioned disadvantages are inhibited, wherein it is sought to provide a means for fixing the gap coverage element which is inexpensive owing to reduced tool usage and which involves the least possible material consumption.

The disclosure presents an arrangement for gap coverage for a variable gap between an adjustable steering column and a dashboard of a vehicle, having a steering column trim and a gap coverage device. According to the disclosure, the gap coverage device has a holding device and a flexible gap coverage element, which at one side is detachably fastened with a frictional positive fit to the holding device and at the other side is connectable to a fastening element, wherein the holding device having the flexible gap coverage element attached thereto is in turn detachably fastened with a frictional positive fit to the steering column trim.

Note that the features and measures individually specified in the following description may be combined with one another in any technically meaningful way and reveal further refinements of the disclosure. The description additionally characterizes and specifies the disclosure, in particular in conjunction with the figures.

The disclosure provides an arrangement for gap coverage for a variable gap between an adjustable steering column and a dashboard of a vehicle, having a steering column trim and a gap coverage device, with which an adequate connection of the flexible gap coverage element to the steering column trim is achieved without the use of special tools and without ultrasonic welding or adhesive bonding. The connection is however expediently detachable, such that the steering column trim can be separated from the gap coverage element at any time when desired. The term “with a frictional positive fit” thus refers to a connection of two connecting partners which are joined together and remain in this joined state until the connection is separated again at desired point in time, without the gap coverage element or the holding device being destroyed.

Here, the term “vehicle” refers in the narrower sense to a road vehicle, that is to say a vehicle that is suitable and approved for on-road use. It may in particular be a passenger car, a heavy goods vehicle, a van or a bus. There are no limitations with regard to the type of drive of the vehicle; the vehicle may for example be powered by an internal combustion engine that uses gasoline, diesel, LPG, hydrogen or some other gas as fuel. Alternatively or in addition, an electric motor may be provided which can be supplied with energy for example by a battery unit and/or a fuel cell. The vehicle may be controllable at least intermittently by a driver. It may however also be designed to at least intermittently drive autonomously, that is to say without being controlled by a driver.

In one example, the holding device may be designed as a U-shaped frame having a base member and having two U limbs which extend away from the base member in the same orientation. In particular, the base limb and U limb are of rectangular form. In the context of the disclosure, rectangular means that the base member and each of the limbs are longer than they are tall, and taller than they are thick. In particular, the base member is designed as a flat member, and each U limb is arranged perpendicularly thereto as a vertical member. A U limb is thus arranged upright on each end of the base member. A particularly stable holding device is thus provided. The holding device may self-evidently also be of some design other than the exemplary U-shaped design. It may for example be of rectangular or square design.

In an expedient refinement, the holding device is produced as a single piece. In particular, the holding device may be manufactured as an injection molded part from a suitable plastics material. It is self-evidently also possible for the base member and U limbs to be produced as separate parts and subsequently connected to one another. Instead of a plastics material, it is self-evidently possible for any suitable material to be used to produce the holding device, wherein production methods suitable for the particular material may also be used.

For the fastening of the flexible gap coverage element to the holding device with a frictional positive fit, that is to say in detachable fashion, the holding device has holding elements, which are arranged both on the base member and on the U limbs so as to project therefrom. In the context of the disclosure, it is expedient if the holding elements are of different design, wherein pairs of identical holding elements may, in one example, be arranged on the base member, and wherein the holding elements of each pair of holding elements are equally spaced from a centerline of the holding device. A central pair of holding elements has holding elements which are each formed from two members which are mutually spaced in the direction of extent of the base member and extend parallel but which are perpendicular to the direction of extent. The direction of extent of the base member means that this extends between the two U limbs. The direction of extent could also be referred to as a central axis of the base member.

A pair of holding elements arranged somewhat further outside the centerline has holding elements designed as cross-shaped elevations, which are designed to be taller than each holding element of the central pair of holding elements.

A pair of holding elements arranged yet further to the outside from the centerline has holding elements which are each of portal-like design with a rounded tip, and which, in one example, extend to the same height as the cross-shaped elevations or holding elements. A central axis of the portal-like holding elements is congruent with a central axis of the cross-shaped holding elements.

A pair of holding elements arranged yet further to the outside from the centerline has holding elements which are each designed as a flat pin which has a reinforcement member oriented away from the centerline and, opposite the reinforcement member, a hook element. The hook element is accordingly oriented in the direction of the centerline. The flat pin is designed to be taller than each cross-shaped holding element and projects beyond a free edge of the U limb arranged on the associated end of the base member.

The last three pairs of holding elements mentioned are arranged with their holding elements on a common central axis. The central pair of holding elements is arranged offset in relation thereto on the base member.

In particular, by way of example, four pairs of different holding elements are arranged on the base member, wherein the holding elements of each pair are, in one example, of identical design. It falls within the scope of the disclosure for more or fewer than the stated number of pairs to be provided, which is dependent on the dimension of the holding device, in particular of the base member thereof, which may have adapted dimensions in its direction of extent.

In one example, the holding elements arranged on the U limbs are likewise of identical design in pairs in relation to the centerline of the holding device, such that one holding element of a pair of holding elements is arranged on one U limb and the other is arranged on the opposite U limb. In a further example, three pairs of holding elements are arranged on the U limbs. In other words, each U limb has three holding elements, which are situated opposite one another and are in particular arranged on a common line. Of these pairs of holding elements, a holding element arranged closest to the base member in each case is T-shaped with a fastening member and a holding member arranged perpendicularly to the fastening member, wherein the fastening member projects from the associated U limb. A pair of holding elements that is spaced further from the base member is designed identically thereto in the form of T-shaped holding elements, and can be referred to as a central pair. A pair of holding elements spaced yet further from the base member has holding elements which are each portal-like, and barbs are arranged on the flexible portal members, projecting from the U limbs, of the holding elements, wherein the portal members transition into a flattened connecting member, which connecting member is arranged parallel to the longitudinal extent of the U limbs and connects the two portal members to one another. It is self-evidently also the case here that the stated number of pairs may vary based on the dimensions of the U limbs. The hook element arranged on that holding element of the base member which is designed as a flat pin could also be regarded as a pair of holding elements, which would be assigned to the associated U limb.

In one example, the flexible gap coverage element is designed as a tetragonal flat element, on one side of which a holding device wing is arranged, opposite this on the other side a fastening wing is arranged, and on the interposed free sides folding wings are arranged. Here, the flexible gap coverage element has a visible side and, opposite this, a bottom side. The visible side is the side that is visible in the assembled state. The visible side may be structured, and may in particular be identically matched to the form of the visible side of the steering column trim, such that a cohesive and enhanced overall appearance of the arrangement for gap coverage is achieved in the assembled state. In particular, the flexible gap coverage element is formed from a plastics material, for example from PVC (polyvinyl chloride, or vinyl for short), a synthetic leather or some other suitable material, as a single piece, in particular by being cut or punched as a single piece out of a mat.

In a further example, the flexible gap coverage element has openings designed correspondingly to the holding elements, such that the flexible gap coverage element can be easily detachably fastened to the holding device without the use of tools. In particular, the flexible gap coverage element has, on its holding device wing, openings corresponding to the holding elements arranged on the base member, wherein the openings corresponding to the holding elements arranged on the U limbs are arranged on the mutually opposite folding wings. Openings may also be arranged on the fastening wing, by means of which openings the fastening element can be connected to the flexible gap coverage element.

In one example, the openings are formed into the flexible gap coverage element as the latter is cut or punched out into the desired shape and size. The openings may however also be formed in the relevant wing at a later point in time. In particular, the openings may be formed into the flexible gap coverage element as elongated holes and/or as cross-shaped holes and/or as tetragonal holes of square or rectangular design, with a punching-out or cutting-out operation being envisaged in particular, though this is not intended to constitute a limitation. The aforementioned geometrical design of the openings is also not intended to constitute a limitation. For example, circular or oval or other designs of the openings are conceivable.

By means of the mutually corresponding openings and holding elements, the flexible gap coverage element can be detachably fastened in securely positioned fashion to the holding device, in particular without the use of tools and without the use of welding equipment such as ultrasonic welding equipment, and also without the use of an adhesive. For this purpose, the holding device is placed with its base member under the bottom side of the flexible gap coverage element, in particular under the holding device wing thereof, such that the U limbs extend away from the flexible gap coverage element. The holding device is then simply connected by way of its base member to the holding device wing of the flexible gap coverage element by virtue of the holding elements being pushed through the openings arranged in the wing. By virtue of the flexible gap coverage element being folded through 180° around the base member, the holding device comes to lie with its U limbs on the bottom side of the flexible gap coverage element between the folding wings on the flexible gap coverage element. The folding wings can then be folded around the associated U limb and be detachably fixed to the holding elements, which engage into the openings arranged in the wings. The openings and holding elements are designed, in interaction with the base member and the U limbs, such that the flexible gap coverage element is stretched, so to speak, over the holding device and cannot unintentionally become detached counter to the tension force. The holding device is completely enveloped, so to speak, by the associated wing. Detachment is nevertheless possible when desired, which is achieved by detaching each of the wings by undoing the connection of holding element and receptacle of the U limbs and the base member counter to the tension force. The fitted-together holding elements and openings give rise, in interaction with the base member and the U limbs, to automatic centering of the flexible gap coverage element on the holding device, which further reduces the assembly time for the preassembly of the gap coverage device.

This gap coverage device which has been preassembled in this way can be connected to the steering column trim. In one example, at least some of the aforementioned holding elements are suitable for this purpose, which holding elements thus advantageously have a dual function. These firstly serve to connect the flexible gap coverage element to the holding device with a frictional positive fit. They secondly serve to connect the gap coverage device to the steering column trim by means of the holding device. For this purpose, counterpart elements designed correspondingly to the associated holding elements are arranged on the steering column trim.

In one example, the steering column trim has for this purpose a counterpart member which corresponds to the base member and has receptacles corresponding to the holding elements arranged on the base member. In one example, counterpart limbs corresponding to the U limbs to be arranged on the steering column trim, which counterpart limbs have receptacles corresponding to the holding elements arranged on the U limbs.

The associated holding elements simply need to be inserted into the corresponding receptacles and engage through or into these, wherein a clip connection is thus established which is detachable only when desired. Engagement is more clearly perceptible owing to corresponding connection noises, such that the technician is provided with an indication of an adequate connection. It is expedient here that the cross-shaped holding elements of the base member can function as centering pins, which greatly simplifies the assembly process.

In one example, for each of the holding elements arranged on the holding device, a corresponding receptacle is arranged on the steering column trim. In a further example, each of the holding elements arranged on the base member of the holding device engages through the respectively corresponding receptacle on the counterpart member of the steering column trim, wherein holding elements and receptacles are designed such that they connect together and can thus also be separated again counter to the connecting force when desired. In a yet further example, only the portal-like holding element on the U limbs of the holding device engages through the corresponding receptacle in the counterpart limbs of the steering column trim, wherein the flexible portal members deflect as they are pushed into the corresponding receptacles and, after the barbs have passed corresponding counterpart surfaces, the portal members move back into the initial position such that the barbs engage behind the corresponding counterpart surface of the corresponding receptacle. By contrast, the T-shaped holding elements on the U limbs merely engage into the respectively corresponding receptacles in the counterpart limbs, without engaging through them. Although no connection is provided here, it is nevertheless also the case here that adequately secure positioning is achieved by virtue of the holding elements and receptacles being designed appropriately.

In a known manner, the steering column trim has an upper cover and a lower cover that are connectable to one another. In one example, the preassembled gap coverage device is connected to the upper cover of the steering column trim. The upper cover together with the gap coverage device can be connected to the lower cover, such that these elements can also be non-destructively separated from one another when desired.

In a further aspect of the disclosure, a method for producing a gap coverage device of the type described above is presented. The gap coverage device is suitable for connection to a steering column trim, in particular to the upper cover thereof, in order to cover a variable gap between an adjustable steering column and a dashboard of a vehicle.

The method comprises at least the following steps. The method includes providing a holding device of U-shaped form having a base member and having U limbs which extend away from the base member in the same orientation, wherein holding elements are arranged on the base member and on the U limbs. The method includes providing a flexible gap coverage element on which openings corresponding to the holding elements are arranged is provided; and firstly the holding device and the flexible gap coverage element are brought together such that the base member of the holding device is placed against a bottom side of the flexible gap coverage element, such that the U limbs extend away from the flexible gap coverage element. The method includes the holding elements arranged on the base member are pushed into the corresponding openings in the flexible gap coverage element, and the flexible gap coverage element is folded around the base member such that the U limbs lie on the bottom side of the flexible gap coverage element at least in certain regions. The method includes folding wings, which are arranged on the flexible gap coverage element, are folded around the U limbs of the holding device under tension, and the holding elements arranged on the U limbs are connected to the corresponding openings in the flexible gap coverage element, and the holding device is connected to the steering column trim by virtue of at least some of the holding elements arranged on the holding device connecting with a frictional positive fit into corresponding receptacles in the steering column trim.

With the method according to the disclosure, it is possible to dispense with special tools and welding equipment, such as ultrasonic welding equipment, or adhesives to produce the gap coverage device. Rather, in an ideal refinement, a method is presented with which, whilst dispensing with an integrally bonded connection to the holding device, the flexible gap coverage element can nevertheless be fastened in adequately securely positioned fashion. This is achieved by way of the fixing with a frictional positive fit, wherein only the holding elements engage into the corresponding openings in the flexible gap coverage element. The flexible gap coverage element is thus stretched over the holding device and simultaneously centered.

In one example of the method, in order to provide the holding device, the holding device is produced as a single piece, wherein the holding device is manufactured in particular as an injection molded part from a suitable plastics material. It is self-evidently also possible for the base member and U limbs to be produced as separate parts and subsequently connected to one another.

For the fastening of the flexible gap coverage element to the holding device with a frictional positive fit, that is to say in detachable fashion, the holding device has holding elements, which are arranged both on the base member and on the U limbs so as to project therefrom and which, during the production of the holding device, are also produced simultaneously, in particular in a common injection molding process. The holding elements may self-evidently also be produced in a common production process with the base member, which is to be manufactured separately, and the U limbs, in particular in a plastics injection molding process.

With regard to the design and arrangement of the holding elements, reference is made to the description above, the entire content of which is to be incorporated here.

In an expedient refinement of the method, the flexible gap coverage element is produced as a single piece as a tetragonal flat element, on which a holding device wing and an oppositely situated fastening wing are arranged and on the interposed free sides in each case one folding wing is arranged, wherein the openings corresponding to the holding elements of the holding device are formed in the holding device wing and in the two folding wings. Openings may also be formed in the fastening wing, such that a fastening element can be fastened to the fastening wing. A connection to the dashboard can be established by means of the fastening element, such that the gap coverage device is fixed by means of the holding device to the steering column trim, and oppositely thereto by means of the fastening element. Owing to the flexible design of the flexible gap coverage element, the movements of the steering column can be compensated for, and the gap remains covered. This is made possible in particular by means of a portion of the flexible gap coverage element which is not stretched over the holding device, the portion being arranged in particular between the fastening wing and a free end of the U limbs of the holding device.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a visible side of an arrangement for gap coverage, having a steering column trim and having a gap coverage device, according to one form of the present disclosure;

FIG. 2 is a perspective view of a bottom side of the arrangement for gap coverage from FIG. 1;

FIG. 3 is a detail view of a holding device according to one form of the present disclosure;

FIG. 4 is a detail view of a flexible gap coverage element according to one form of the present disclosure;

FIG. 5 is a top view of the gap coverage element connected to the holding device, in a first preassembly state according to one form of the present disclosure;

FIG. 6 is a top view of the gap coverage element connected to the holding device, in a further preassembly state according to one form of the present disclosure; and

FIG. 7 is a top view of the gap coverage element connected to the holding device, in a final preassembly state according to one form of the present disclosure.

In the drawings, the same or similar elements and/or parts are provided with the same reference numbers, so that they are not presented again.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

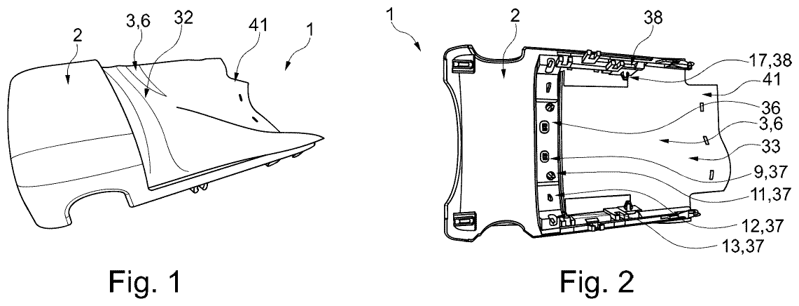

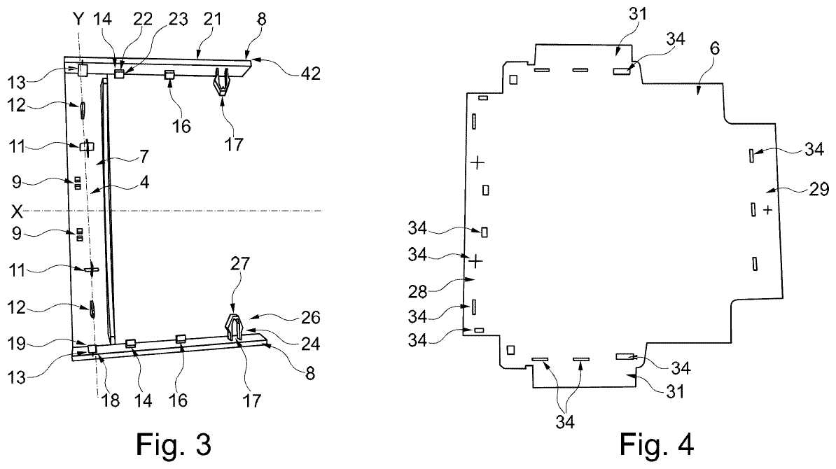

FIGS. 1 and 2 show an arrangement 1 for gap coverage for a variable gap between an adjustable steering column and a dashboard of a vehicle, having a steering column trim 2 and a gap coverage device 3. The gap coverage device 3 has a holding device 4 and a flexible gap coverage element 6, which at one side is detachably fastened with a frictional positive fit to the holding device 4 and at the other side is connectable to a fastening element (not illustrated in the figures), wherein the holding device 4 is in turn detachably fastened with a frictional positive fit to the steering column trim 2. The holding device 4 is concealed in FIGS. 1 and 2, and can be seen most clearly in FIGS. 3 and 5 to 7.

In a known manner, the steering column trim 2 has an upper cover and a lower cover that are connectable to one another. The gap coverage device 3 is connected to the upper cover of the steering column trim 2. The upper cover together with the gap coverage device 3 can also be connected to the lower cover, such that these elements can be non-destructively separated from one another when required. In the example illustrated, an upper cover of the steering column trim 2 is shown.

In the example illustrated in FIG. 3, the holding device 4 is designed as a U-shaped frame having a base member 7 and having two U limbs 8 which extend away from the base member 7 in the same orientation. As can be seen, the base limb 7 and U limbs 8 are, by way of example, of rectangular form. Here, the base member 7 and each U limb 8 are longer than they are tall, and taller than they are thick. It could also be the that they are of plate-like form. In particular, the base member 7 is designed as a flat member, and each U limb 8 is arranged perpendicularly thereto as a vertical member. A U limb 8 is thus arranged upright on each end of the base member 7.

For the fastening of the flexible gap coverage element 6 to the holding device 4 with a frictional positive fit, that is to say in detachable fashion, the holding device 4 has holding elements 9, 11, 12, 13, 14, 16, 17, which are arranged both on the base member 7 and on the U limbs 8 so as to project therefrom. As can be seen, the holding elements 9, 11, 12, 13, 14, 16, 17 are of different design, wherein pairs of identical holding elements 9, 11, 12, 13 are arranged on the base member 7, and wherein the holding elements 9, 11, 12, 13 of each pair of holding elements are equally spaced from a centerline X of the holding device 4.

A central pair of holding elements has holding elements 9 which are each formed from two members which are mutually spaced in the direction of extent of the base member 7 and extend parallel but which are perpendicular to the direction of extent.

A pair of holding elements arranged somewhat further outside the centerline X has holding elements 11 designed as cross-shaped elevations, which are designed to be taller than each holding element 9 of the central pair of holding elements.

A pair of holding elements arranged yet further to the outside from the centerline X has holding elements 12 which are each of portal-like design with a rounded tip, and which, in one example, extend to the same height as the cross-shaped holding elements 11. Arranged centrally in these holding elements 12 is a slot that extends as far as the base member 7. A central axis Y of the portal-like holding elements 12 is congruent with a central axis Y of the cross-shaped holding elements 11.

A pair of holding elements arranged yet further to the outside from the centerline X has holding elements 13 which are each designed as a flat pin which has a reinforcement member 18 oriented away from the centerline X and, opposite the reinforcement member 18, a hook element 19. The hook element 19 is accordingly oriented in the direction of the centerline X. The flat pin is designed to be taller than each cross-shaped holding element 11 and than the portal-like holding element 12, and projects beyond a free edge 21 of the U limb 8 arranged on the associated end of the base member 7.

The last three pairs of holding elements mentioned are arranged on a common central axis Y. In the plane of the drawing in FIG. 3, the central pair of holding elements is arranged offset to the left in relation thereto on the base member 7.

In particular, therefore, four pairs of different holding elements 9, 11, 12, 13 are arranged on the base member 7, wherein the holding elements 9, 11, 12, 13 of each pair are, in one example, of identical design.

As illustrated by way of example, the holding elements 14, 16, 17 arranged on the U limbs 8 are likewise of identical design in pairs in relation to the centerline X of the holding device 4, such that one holding element 14, 16, 17 of a pair of holding elements is arranged on one U limb 8 and the other is arranged on the opposite U limb 8. Three pairs of holding elements are thus arranged on the U limbs 8. In other words, each U limb 8 has three holding elements 14, 16, 17, which are situated opposite one another in relation to the centerline X and are in particular arranged on a common axis of arrangement.

Of these pairs of holding elements, a holding element 14 arranged closest to the base member 7 in each case is T-shaped with a fastening member 22 and a holding member 23 arranged perpendicularly to the fastening member 22, wherein the fastening member 22 projects from the associated U limb 8. A pair of holding elements that is spaced further from the base member 7 is designed identically thereto in the form of T-shaped holding elements 16, and can be referred to as a central pair. A pair of holding elements spaced yet further from the base member 7 has holding elements 17 which are each portal-like, and barbs 26 are arranged on the flexible portal members 24, projecting from the U limbs 8, of the holding elements 17, wherein the flexible portal members 24 transition into a flattened connecting member 27, which the flattened connecting member 27 is arranged parallel to the longitudinal extent of the U limbs 8.

As can be seen in FIG. 4, the flexible gap coverage element 6 is designed as a tetragonal flat element, on one side of which a holding device wing 28 is arranged, opposite this on the other side a fastening wing 29 is arranged, and on the interposed free sides folding wings 31 are arranged. Here, the flexible gap coverage element 6 has a visible side 32 and, opposite this, a bottom side 33. The visible side 32 is the side that is visible in the assembled state.

It can also be seen in FIG. 4 that the flexible gap coverage element 6 has openings 34 designed correspondingly to the holding elements 9, 11, 12, 13, 14, 16, 17, such that the flexible gap coverage element 6 can be easily detachably fastened to the holding device 4. By way of example, the flexible gap coverage element 6 has, on its holding device wing 28, openings 34 corresponding to the holding elements 9, 11, 12, 13 arranged on the base member 7, wherein the openings 34 corresponding to the holding elements 14, 16, 17 arranged on the U limbs 8 are arranged on the mutually opposite folding wings 31. Openings 34 are also arranged on the fastening wing 29, by means of which openings 34 of the fastening element can be connected to the flexible gap coverage element 6.

The openings 34 may be formed as elongate holes and/or as cross-shaped holes and/or as tetragonal holes of square or rectangular form in the flexible gap coverage element 6, and designed such that the respectively corresponding holding elements 9, 11, 12, 13, 14, 16, 17 lie with at least one region, that is to say at least with an edge or with at least a side, against at least a margin of the openings 34.

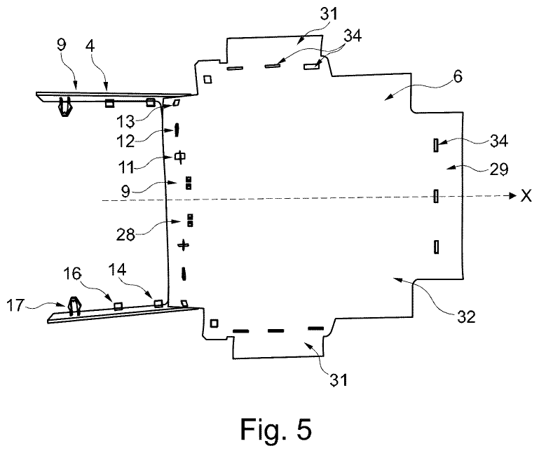

The assembly steps for connecting the holding device 4 to the flexible gap coverage element 6 are illustrated by way of example in FIGS. 5 to 7.

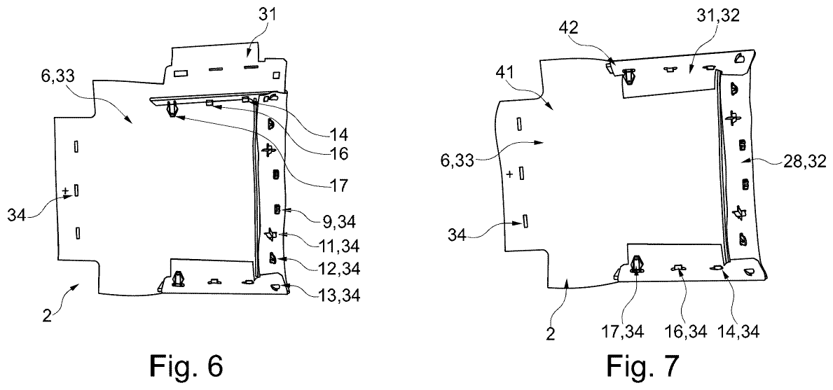

The holding device 4 is firstly placed with its base member 7 under the bottom side 33 of the flexible gap coverage element 6, in particular under the holding device wing 28 thereof, such that the U limbs 8 extend away from the flexible gap coverage element 6, as can be seen in FIG. 5. In the example illustrated in FIG. 5, the U limbs 8 extend toward the left-hand side. The holding device 4 is then simply connected by way of its base member 7 to the holding device wing 28 of the flexible gap coverage element 6 by virtue of the holding elements 9, 11, 12, 13 being pushed through the openings 34 arranged in the holding device wing 28. By virtue of the flexible gap coverage element 6 being folded through 180° around the base member 7, the holding device 4 comes to lie with its U limbs 8 on the bottom side 33 of the flexible gap coverage element 6 between the folding wings 31 on the flexible gap coverage element 6. This can be seen in FIGS. 6 and 7, wherein the steps of folding the folding wings 31 have already been performed. The folding wings 31 can thus be folded around the associated U limb 8 and detachably fixed to the holding elements 14, 16, 17, which engage into the openings 34. The openings 34 and holding elements 9, 11, 12, 13, 14, 16, 17 are designed, in interaction with the base member 7 and the U limbs 8, such that the flexible gap coverage element 6 is stretched, so to speak, over the holding device 4 and cannot unintentionally become detached counter to the tension force. The holding device 4 is completely enveloped, so to speak, by the associated wing 28, 29, wherein the bottom side 33 can be seen on the inside, that is to say in FIGS. 6 and 7, and the visible side 32 of the flexible gap coverage element 6 cannot be seen in these figures. Only on the folded folding wings 31 and on the base member 7 that has been covered by the holding device wing 28 can the visible side 32 be seen in FIG. 7.

This gap coverage device 3 which has been preassembled in this way, and which is illustrated in FIG. 7, can be connected to the steering column trim 2, that is to say to the upper cover thereof. In one example, some of the aforementioned holding elements 9, 11, 12, 13, 14, 16, 17 have been suitably designed for this purpose, which holding elements 9, 11, 12, 13, 14, 16, 17 thus advantageously have a dual function. These firstly serve to connect the flexible gap coverage element 6 to the holding device 4 with a frictional positive fit. They secondly serve to connect the gap coverage device 3 to the steering column trim 2, that is to say to the upper cover thereof, by means of the holding device 4. For this purpose, counterpart elements designed correspondingly to the holding device 4 are arranged on the steering column trim 2, that is to say on the upper cover thereof.

It can also be seen in FIG. 7 that the visible side 32 of the folding wings 31 and of the holding device wing 28 are arranged on an inner side of the gap coverage device 3, so to speak.

As can be seen in FIG. 2, the steering column trim 2, that is to say the upper cover thereof, has for this purpose a counterpart member 36 as a corresponding counterpart element, which counterpart member corresponds to the base member 7 and has receptacles 37 corresponding to the holding elements 9, 11, 12, 13 arranged on the base member 7. As can also be seen in FIG. 2, counterpart limbs 38 as corresponding counterpart elements are arranged on the steering column trim 2, that is to say on the upper cover thereof, which counterpart limbs 38 correspond to the U limbs 8 and have receptacles 39 corresponding to the holding elements 14, 16, 17 arranged on the U limbs 8.

The associated holding elements 9, 11, 12, 13, 14, 16, 17 simply need to be inserted into the corresponding receptacles 37, 39 and engage through or into these, wherein a clip connection is thus established which is detachable only when desired. Engagement is more clearly perceptible owing to corresponding connecting noises, such that the technician is provided with an indication of an adequate connection.

By way of example, for each of the holding elements 9, 11, 12, 13, 14, 16, 17 arranged on the holding device 4, a corresponding receptacle 37, 39 is arranged on the steering column trim 2, that is to say on the upper cover thereof. Here, each of the holding elements 9, 11, 12, 13 arranged on the base member 7 of the holding device 4 engages through the respectively corresponding receptacle 38 on the counterpart member 36 of the steering column trim 2, that is to say of the upper cover, wherein holding elements 9, 11, 12, 13 and receptacles 38 are designed such that they connect together and can thus also be separated again counter to the connecting force when desired. As can also be seen in FIG. 2, only the portal-like holding element 17 on the U limbs 8 of the holding device 4 engages through the corresponding receptacle 39 in the counterpart limbs 38 of the steering column trim 2, that is to say in the upper cover thereof, wherein the flexible portal members 24 deflect as they are pushed into the corresponding receptacle 38 and, after the barbs 26 have passed the corresponding counterpart surface, the portal members move back into the initial position such that the barbs 26 engage behind the corresponding counterpart surface of the corresponding receptacle 39.

By contrast, the T-shaped holding elements 14, 16 on the U limbs 8 merely engage into the respectively corresponding receptacles 39 in the counterpart limbs 39, without engaging through them. It is nevertheless also the case here that adequately secure positioning is achieved by virtue of the holding elements 14, 16 and receptacles 39 being designed appropriately.

As can be seen most clearly in FIGS. 5 to 7, openings 34 are also formed in the fastening wing 29, such that a fastening element can be fastened to the fastening wing 29. A connection to the dashboard can be established by means of the fastening element, such that the gap coverage device 3 is fixed by means of the holding device 4 to the steering column trim 2, that is to say to the upper cover thereof, and oppositely thereto by means of the fastening element. Owing to the flexible design of the flexible gap coverage element 6, the movements of the steering column can be compensated for, and the gap remains covered. This is made possible in particular by means of a portion 41 of the flexible gap coverage element 6 which is not stretched over the holding device 4, the portion 41 being arranged in particular between the fastening wing 29 and a free end 42 of the U limbs 8 of the holding device 4.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An arrangement for gap coverage for a variable gap between an adjustable steering column and a dashboard of a vehicle, the arrangement comprising:
a steering column trim; and
a gap coverage device including a holding device and a flexible gap coverage element, a first side of the flexible gap coverage element is detachably fastened with a frictional positive fit to the holding device and a second side of the flexible gap coverage element is configured to connect to a fastening element, and the holding device having the flexible gap coverage element attached thereto is detachably fastened with a frictional positive fit to the steering column trim.

2. The arrangement according to claim 1, wherein the holding device is a single piece.

3. The arrangement according to claim 1, wherein the holding device is a U-shaped frame including a base member and two U limbs which extend away from the base member in the same orientation.

4. The arrangement according to claim 3, wherein the holding device includes holding elements arranged on the base member and the two U limbs that project away from the base member and the two U limbs.

5. The arrangement according to claim 4, wherein the holding elements include a first pair of the holding elements and a second pair of the holding elements, each pair of the first pair of the holding elements and the second pair of the holding elements include identical holding elements arranged on the base member, and the holding elements of each pair of the holding elements are equally spaced from a centerline of the holding device.

6. The arrangement according to claim 4, wherein the holding elements arranged on the two U limbs are arranged in pairs of identical holding elements in relation to a centerline of the holding device, such that a first holding element of the pair of holding elements is arranged on one U limb and a second holding element of the pair of holding elements is arranged on an opposite U limb.

7. The arrangement according to claim 4, wherein the flexible gap coverage element is a tetragonal flat element that includes a holding device wing arranged on one side of the tetragonal flat element, a fastening wing arranged on an opposite side of the tetragonal flat element, and folding wings arranged on interposed free sides of the tetragonal flat element.

8. The arrangement according to claim 7, wherein the flexible gap coverage element includes openings corresponding to the holding elements arranged on the holding device.

9. The arrangement according to claim 8, wherein the holding device and the base member are configured to be coupled under a bottom side of the flexible gap coverage element such that the two U limbs extend away from the flexible gap coverage element, the holding elements are configured to push through the corresponding openings, the flexible gap coverage element is configured to be folded around the base member such that the holding device lies with the two U limbs between the folding wings on the bottom side of the flexible gap coverage element at least in certain regions, and the folding wings are configured to be folded around an associated U limb of the two U limbs and are detachably fixed to the holding elements, which are engaged with the corresponding openings.

10. The arrangement according to claim 7, wherein the holding device wing of the flexible gap coverage element includes, openings corresponding to the holding elements arranged on the base member, the openings corresponding to the holding elements arranged on the two U limbs are arranged on the folding wings, and receptacles for fastening of the fastening element are arranged on the fastening wing.

11. The arrangement according to claim 10, wherein the holding device and a base member are configured to be coupled under the holding device wing such that the two U limbs extend away from the flexible gap coverage element, the holding elements are configured to push through the corresponding openings, the flexible gap coverage element is configured to be folded around the base member such that the holding device lies with the two U limbs between the folding wings on a bottom side of the flexible gap coverage element at least in certain regions, and the folding wings are configured to be folded around an associated U limb of the two U limbs and are detachably fixed to the holding elements, which are engaged with the corresponding openings.

12. The arrangement according to claim 1, wherein in a preassembled state of the gap coverage device, the flexible gap coverage element is stretched over the holding device.

13. The arrangement according to claim 1, further comprising counterpart elements that correspond to the holding device and are arranged on the steering column trim.

14. The arrangement according to claim 13, further comprising receptacles arranged on the counterpart elements and are configured to correspond to holding elements arranged on the holding device.

15. The arrangement according to claim 13, wherein the steering column trim includes a counterpart member corresponding to a base member and has receptacles corresponding to the holding elements arranged on the base member.

16. The arrangement according to claim 13, further comprising counterpart limbs corresponding to two U limbs are arranged on the steering column trim and have receptacles corresponding to the holding elements arranged on the two U limbs.

17. An arrangement for gap coverage for a variable gap between an adjustable steering column and a dashboard of a vehicle, the arrangement comprising:
a steering column trim; and
a gap coverage device, comprising:
a holding device that is a U-shaped frame including a base member and two U limbs which extend away from the base member in the same orientation, the holding device includes holding elements arranged on the base member and the two U limbs, and the holding elements project away from the base member and the two U limbs; and
a flexible gap coverage element having a first side of the flexible gap coverage element detachably fastened with a frictional positive fit to the holding device and a second side of the flexible gap coverage element configured to connect to a fastening element,
wherein the holding device having the flexible gap coverage element attached thereto is detachably fastened with a frictional positive fit to the steering column trim.

18. The arrangement according to claim 17, wherein the holding elements includes a first pair of the holding elements and a second pair of the holding elements, wherein each pair of the first pair of the holding elements and the second pair of the holding elements include identical holding elements arranged on the base member, and the holding elements of each pair of the holding elements are equally spaced from a centerline of the holding device.

19. The arrangement according to claim 17, wherein the flexible gap coverage element is a tetragonal flat element, a holding device wing is arranged on one side of the tetragonal flat element, a fastening wing is arranged on an opposite side of the tetragonal flat element, and folding wings are arranged on interposed free sides of the tetragonal flat element.

20. An arrangement for gap coverage for a variable gap between an adjustable steering column and a dashboard of a vehicle, the arrangement comprising:
a steering column trim; and
a gap coverage device comprising:
a holding device that is a U-shaped frame including a base member and two U limbs which extend away from the base member in the same orientation, the holding device includes holding elements arranged on the base member and the two U limbs and the holding elements project away from the base member and the two U limbs; and
a flexible gap coverage element having a first side of the flexible gap coverage element detachably fastened with a frictional positive fit to the holding device and a second side of the flexible gap coverage element configured to connect to a fastening element,
wherein the holding device having the flexible gap coverage element attached thereto is detachably fastened with a frictional positive fit to the steering column trim, and the holding elements includes a first pair of the holding elements and a second pair of the holding elements, each pair of the first pair of the holding elements and the second pair of the holding elements include identical holding elements arranged on the base member, and the holding elements of each pair of the holding elements are equally spaced from a centerline of the holding device.
